(19) United States
(12) Patent Application Publication
(10) Pub. No.: US 2008/0117966 A1
(43) Pub. Date: May 22, 2008

(54) Method and compact apparatus for video capture and transmission with a common interface

(76) Inventors: Pankaj N. Topiwala, Clarksville, MD (US); Basavaraj Mudigoudar, Columbia, MD (US); Sachin Patil, Columbia, MD (US); Wei Dai, Clarksville, MD (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/889,333

(22) Filed: Aug. 10, 2007

Related U.S. Application Data
(60) Provisional application No. 60/836,879, filed on Aug. 10, 2006.

(51) Int. Cl. H04B 1/66

(52) U.S. Cl. 375/240.01

(57) ABSTRACT

A system and method are provided for a highly compact apparatus, instantiated in software firmware, or in a hardware circuit board, whose purpose is multimedia encoder processing; a secondary apparatus, whether instantiated in software, firmware, or hardware, residing in either the same or an external system, for the purpose of providing a graphical user interface, a resource for data packaging, or for streaming; and a third apparatus, also in software, firmware or hardware, for receiving, decoding and displaying the received signal.

### CROSS-REFERENCE TO RELATED APPLICATIONS

This application claims priority to provisional U.S. patent application entitled, A Method and Apparatus for Video Capture and Coding in a USB Apparatus, filed Aug. 10, 2006, having a Ser. No. 60/836,879, the disclosure of which is hereby incorporated by reference in its entirety.

### FIELD OF THE INVENTION

The present invention relates generally to a system and method for the capture and coding of video and audio to computer via a compact encoding apparatus that supports an efficient common transport. More particularly, the present invention relates to the integration of the elements of digitizing, state-of-the art coding, and interfaces in a novel form factor that permits considerable ease of use.

### BACKGROUND OF THE INVENTION

The fields of video and audio coding are well established, with such familiar technologies as MPEG-1, MPEG-2, and MPEG-4 video coding standards, as well as the well-known ITU/H.26x series; and similarly, with audio codes such as MP3, AC-3, and Advanced Audio Coding (AAC). Presently, the most advanced technology for video coding is the international standard, ITU-T/H.264/ISO/IEC MPEG-4, Part 10, “Advanced Video Coding” (AVC) (hereafter “H.264”), released in July 2003, and amended in July 2004. Similarly AAC is presently considered to be the most advanced general purpose technology for audio coding. Prior art software, firmware, hardware, and tools exist to support previous audio/video coding standards. However, the prior art relates to apparatus which pertains to a decade-old MPEG-2 video standard (ca. 1994). The H.264 coding standard, released in 2003 and amended in 2004, was incorporated into Apple's iPod® around 2004, incorporated into Sony's PSP® in 2005, and in Apple's iPhone® in 2007.

This convergence of coding technologies and formats is limited, unforeseen in the marketplace within recent years, and non-existent as it relates to the system and method set forth in the invention disclosed herein. As such, the prior art does not support encoding with the H.264/AVC standard, and fails to provide the highly compact nature and the capture, compression, and delivery capabilities of the system disclosed.

Accordingly, it is desirable to provide a method and apparatus that provides a highly compact apparatus that captures, in one instance, 2-channel audio and 1-channel NTSC/PAL video, and delivers it to a computer via USB, or a network via an Ethernet interface, for local storage or transmission. In another instance, it captures mixed audio/video in either SDI or HD-SDI input format, compresses it, and delivers it again via USB or Ethernet output.

It is further an object of this invention to support the most advanced compression formats for video and audio.

Another object of this invention is to provide users with a highly convenient method for creating content that can be played in popular media apparatus.

It is yet another object of the invention to avoid tape-based storage and provide a user-friendly method incorporating a “no-moving-parts” approach to creating, transferring, storing, and serving rich multimedia content.

### SUMMARY OF THE INVENTION

The foregoing needs are met, to a great extent, by the present invention, wherein in one aspect an apparatus is provided that in some embodiments provide a highly compact apparatus that captures 2-channel audio and 1-channel NTSC/PAL video and delivers it to a personal computer via a USB or Ethernet interface for local storage or transmission. Correspondingly, a method is provided for capturing audio and video and delivering it a personal computer for local storage or transmission.

In accordance with one embodiment of the present invention, a system for audio video capture and transmission is provided, said system comprising a compact, real-time audio video capture and encoder apparatus for audio and video data capture and encoder processing; a transmitting client facility having a real-time transmitter for transmitting the captured and encoded audio and video data; and a receiving client facility having a real-time receiver, a decoder and a renderer apparatus for receiving, decoding, and rendering the captured and encoded audio and video data.

In accordance with another embodiment of the present invention, a system for audio video capture and transmission with streaming capability is provided, said system comprising: a highly compact capture device having a hardware board configured for audio and video data capture and encoder processing; an operating facility for receiving the captured and encoded audio and video data from the highly compact capture device; wherein the operating facility has a graphical user interface for configuration of said capture device, a resource for packaging the data, and streaming means; and wherein said operating facility further includes decoding means and displaying means for decoding and displaying a signal received from the capture device; and wherein the system ingests a plurality of raw audio and/or video analog streams with optional auxiliary data, compresses streams in real-time, packages the compressed data in real-time into a common format for wide platform playback, delivers the data in real-time to an external system via a data transport protocol, provides the graphical user interface for selecting an apparatus parameter within the operating facility to format the compressed data, and streams the compressed data to a receiving device.

In accordance with yet another embodiment of the present invention, a method for audio video capture and transmission with streaming capability is provided, said method comprising: capturing a plurality of raw audio and/or video data from a highly compact capture device; encoding the captured audio and/or video data processing; receiving the captured and encoded audio and/or video data from the highly compact capture device; configuring the capture device via a graphical user interface; compressing streams of the audio and video data in real-time; packaging the compressed data in real-time into a common format for wide platform playback; delivering the data in real-time to an external system via a data transport protocol; providing the graphical user interface for selecting an apparatus parameter within the operating facility to format the compressed data, and streaming the compressed data to a receiving device.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a system architecture diagram according to a first aspect of a preferred embodiment of the invention.

FIG. 2 is a perspective view illustrating a system architecture diagram according to a second aspect of a preferred embodiment of the invention.

FIG. 3 is a perspective view illustrating a system architecture diagram according to a third aspect of a preferred embodiment of the invention.

FIG. 4 is an illustration of the physical dimensionality of the SmartCapture™ apparatus according to a preferred embodiment of the present invention.

FIG. 5 is a photograph of an exemplary SmartCapture™ hardware prototype.

FIG. 6A is a first perspective view of the SmartCapture™ apparatus in accordance with a preferred embodiment of the present invention.

FIG. 6B is a second perspective view of the SmartCapture™ apparatus in accordance with a preferred embodiment of the present invention.

FIG. 7 illustrates an exemplary SmartCapture™ graphic user interface and display.

FIG. 8 is a perspective view illustrating a system architecture diagram according to a second embodiment of the invention.

FIG. 9 provides a photograph pictorial of the system of a second embodiment of the present invention.

FIG. 10 is a detail view of an exemplary SmartPlayer graphic user interface in accordance with a second embodiment of the invention.

FIG. 11 provides a first photograph pictorial of the system of a third embodiment of the present invention.

FIG. 12 provides a second photograph pictorial of the system of a third embodiment of the present invention.

FIG. 13 is a detail view of hardware decoder circuitry for the SmartCapture™ apparatus in accordance with a preferred embodiment of the invention.

FIG. 14 is a detail view of hardware encoder circuitry for the SmartCapture™ apparatus in accordance with a preferred embodiment of the invention.

FIG. 15 is a perspective view of a Host CPU of a SmartCapture™ apparatus with power supply and external RS232 port in accordance with a preferred embodiment of the invention.

FIG. 16 is a detail view of host central processing unit circuitry in accordance with a preferred embodiment of the invention.

FIG. 17 is a perspective view illustrating the power circuitry of the SmartCapture™ apparatus according to a preferred embodiment of the invention.

FIG. 18A is a schematic overview diagram of layer 1 of a printed circuit board assembly in accordance with an embodiment of the invention.

FIG. 18B is a schematic overview diagram of layer 10 of a printed circuit board assembly in accordance with an embodiment of the invention.

FIG. 19 illustrates the detail of a 10-layer board for the SmartCapture™ apparatus.

FIG. 20 is a drill chart according to an alternative embodiment of the invention.

FIG. 21 is a drill chart according to an alternative embodiment of the invention.

FIG. 22 is a detail view of the SmartCapture™ panelization according to an alternative embodiment of the invention.

### DETAILED DESCRIPTION

The invention will now be described with reference to the drawing figures, in which like reference numerals refer to like parts throughout. An embodiment in accordance with the present invention provides a method as well as an apparatus comprised of a three-part system, comprising: a highly compact apparatus, whether instantiated in software (computer-readable code), firmware (specialized software for a digital signal processor (DSP)), VHDL (Very High Speed Integrated Circuit (VHSIC) Hardware Description Language, a specialized language for programming field programmable gate arrays (FPGAs)), or in a hardware circuit board, whose purpose is multimedia encoder processing; a secondary apparatus, whether instantiated in software, firmware, or hardware, residing in either the same or an external system, for the purpose of providing a graphical user interface, a resource for data packaging, or for streaming; and a third apparatus, also in software, firmware or hardware, for receiving, decoding and displaying the received signal, which in total provides several functionalities benefiting the user.

The system according to the present invention ingests raw audio and/or video streams, whether analog or digital, together with optional auxiliary data such as metadata. The raw combination of audio/video/auxiliary data streams is compressed in real-time (or faster) using state-of-the-art audio and video codecs, plus optional coding of auxiliary data, wherein the compressed data is packaged in real-time (or faster) into a common format for wide platform playback. The data is delivered in real-time (or faster) to an external system such as a computer via common data transport protocols such as USB or Ethernet

The system according to the present invention optionally streams the compressed formatted data to a third apparatus such as a PC, using common network transport protocols such as TCP/IP or RTP/RTCP over UDP, and provides a simple graphical user interface for convenient apparatus parameter selection, and it provides an ability to receive, decode, and display the received, compressed signal. The capture apparatus of the system is referred to herein as SmartCapture™. Thus, SmartCapture™ is a highly compact audio/video capture/encoding apparatus with an accessible external interface and a convenient graphical user interface (GUI).

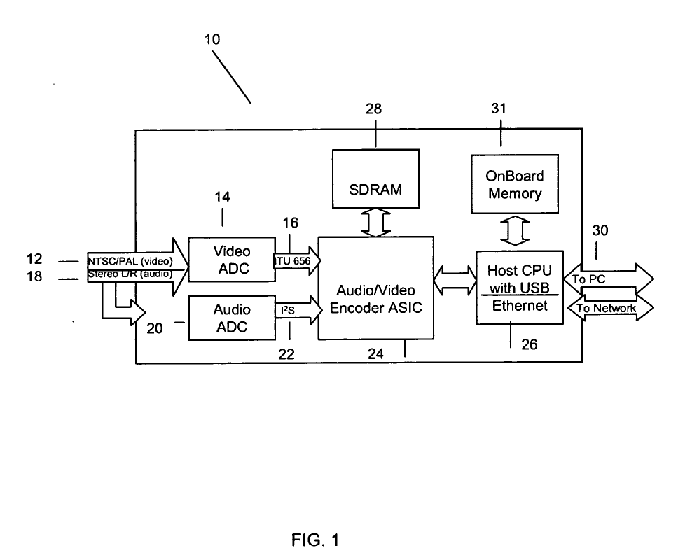

An embodiment of a first hardware aspect of the present inventive SmartCapture™ apparatus and method is illustrated in FIG. 1. The SmartCapture™ apparatus 10 is a Universal Serial Bus (USB) based and powered, having an exemplary small form factor of approximately 10 mm×15 mm×60 mm. The SmartCapture™ 10 digitizes NTSC or PAL analog video input 12 via a Video Analog-To-Digital Converter (Video ADC) 14 to the ITU656 specification 16. The apparatus also digitizes analog audio input 18 via an Audio ADC 20 to a 48 KHz audio stereo PCM samples and digitizes output via the I²S interface 22. Digitized audio and video inputs are fed to an audio/video encoder unit 24 (hereinafter called the AVEncoder). The AVEncoder 24 is controlled by a Host Central Processing Unit (Host CPU) 26 and has a dedicated Synchronous Dynamic Random Access Memory (SDRAM) 28. The Host CPU 26 transfers encoded data through the external interface 30 (e.g., USB to the PC) and provides an interface to control the entire encoding process.

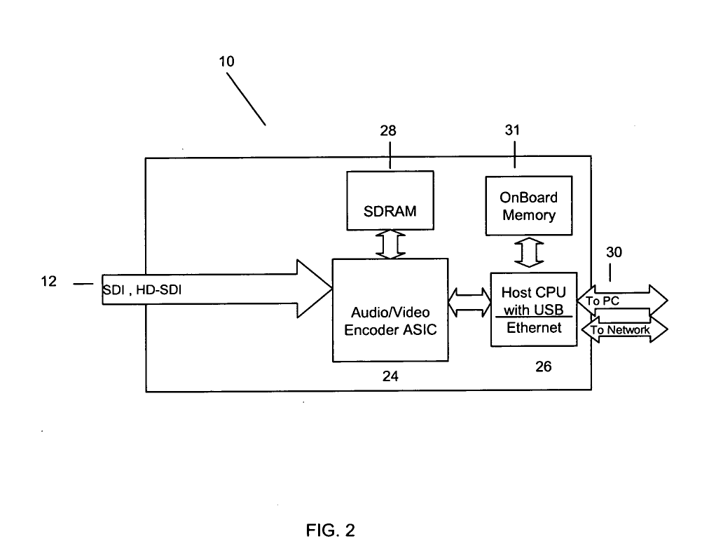

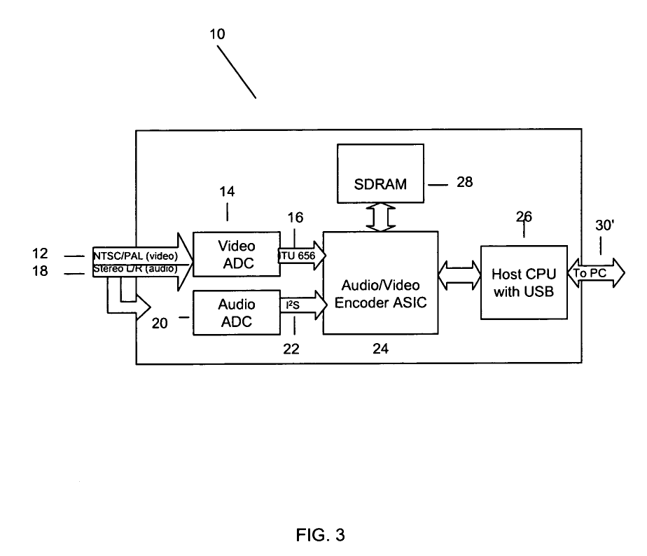

In a second aspect of this embodiment, illustrated in FIG. 2, the input is a Serial Digital Interface (SDI), or High Definition SDI (HD-SDI) 14′ to supplant the Video ADC 14. With respect to FIG. 3, a third aspect of this embodiment is shown, wherein the output is Ethernet 30′. In this third aspect, an additional power source can be added. It is noted that an RS232 port (not shown) can be added into the apparatus to serve as an input for auxiliary data such as Key Length Value (KLV) metadata.

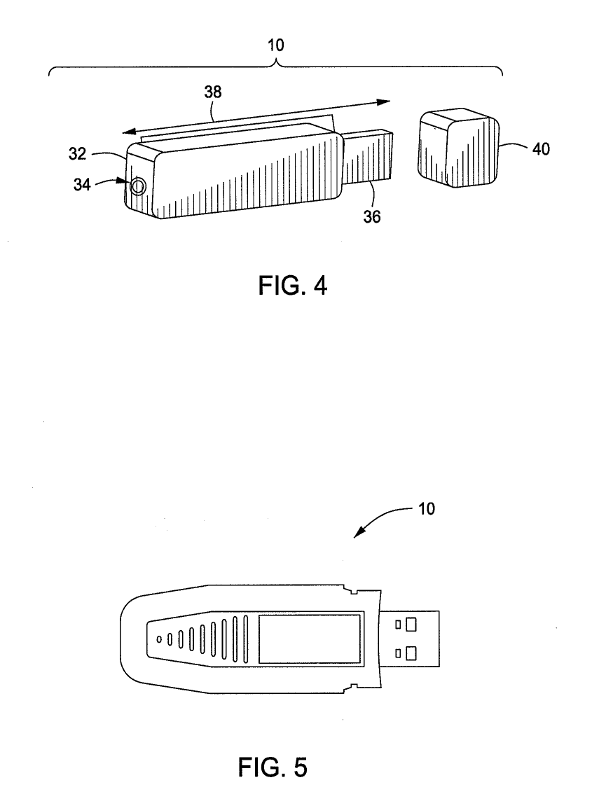

FIG. 4 illustrates exemplary physical dimensionality of the SmartCapture™ apparatus 10. The apparatus 10 has a casing 32 having an approximately 3.5 mm A/V socket 34 on a left end and a USB connector 36 on a right end. A USB hardware board 38 resides within the casing 32. A connector cap 40 is removably fixed onto the right end of the casing 32 to protect USB connector 36. The length of the apparatus 10 is approximately 70 mm, with an approximate width of 20 mm. In total, the system disclosed herein supports video, audio, and auxiliary data as input, and provides a packaged, compressed output.

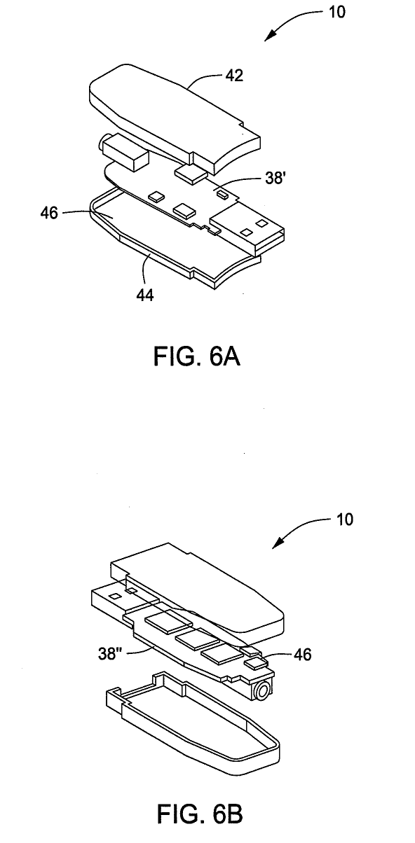

With reference to FIG. 5, an exemplary photograph of a preferred embodiment of the SmartCapture™ apparatus 10 is shown. FIG. 6A provides a first perspective view of the components of the apparatus 10. wherein the casing 32 comprises a top casing 42 and a bottom casing 44, wherein the top casing 42 and bottom casing 44 have male and female receiving portions for fitting said casings together. Conceptual views of USB hardware board 38 are displayed in FIGS. 6A and 6B wherein the top and bottom sides 38′ and 38″ of the board 38 are shown, respectively. A plurality of chips 46 are placed within the board 38. Chips 46 include a USB mass storage controller apparatus and a flash memory chip and other standard chips, as is well known in the art.

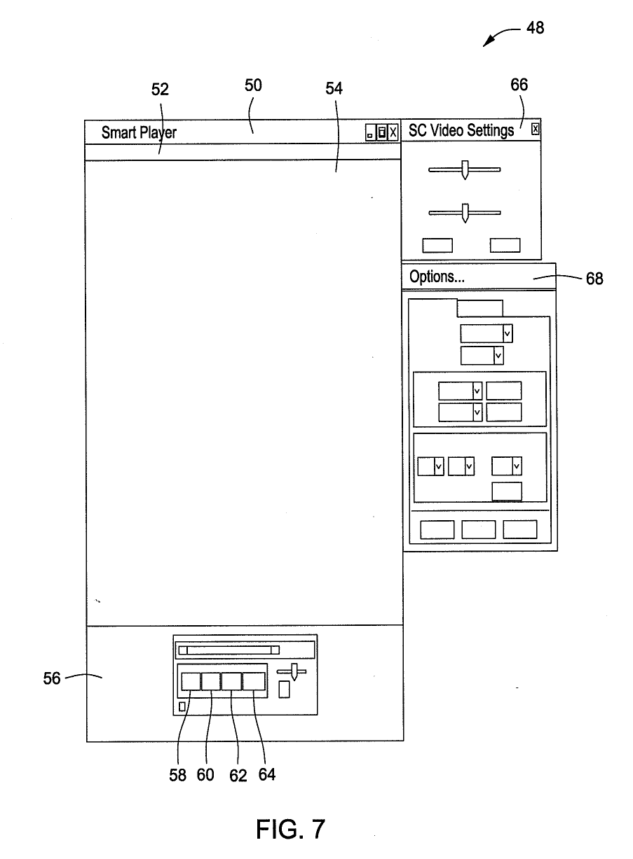

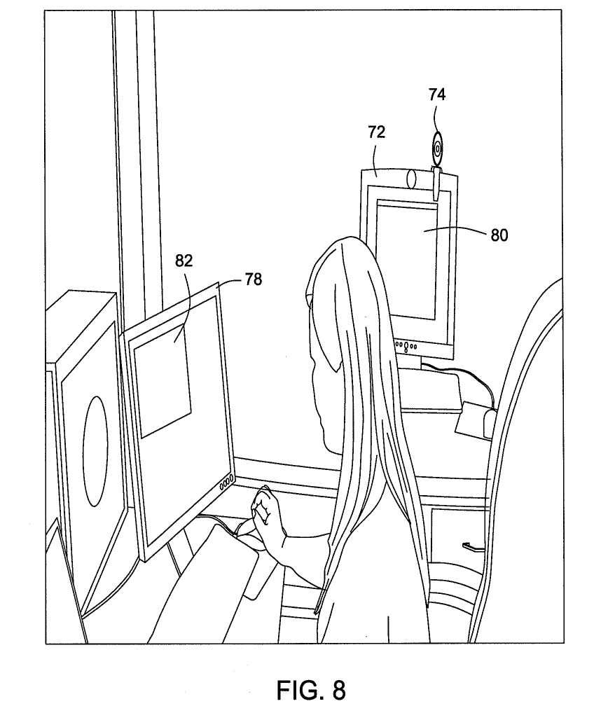

When the USB connector 36 is inserted into a USB port on a transmitting computer, the SmartPlayer system comprising the software component of the present invention is employed and graphical user interface (GUI) 50 is activated on the host computer's screen 48, as illustrated in FIG. 7. FIG. 7 displays an exemplary SmartPlayer GUI 50 having an operations menu bar 52 wherein individual File, Tools, Play, and Help menus are displayed. Below menu bar 52 is the SmartPlayer screen 54. Directly beneath the screen 54 is a command area 56 containing activity buttons 58-64 to enable a user to view one or streams received by the SmartCapture™ 100, record data, stream data, adjust volume, or adjust settings for the files to be displayed in screen 54. When the settings button 64 is activated, SC Video Settings screen 66 is deployed, wherein the user may adjust the brightness and color settings to his or her preference or may select the default settings, as shown.

Using the operations menu bar 54, a user may employ the Options screen 68. Device Settings and Record Settings subscreens are illustrated. Using the Device settings subscreen, the user may select from drop down menus to indicated the type of encoding, presets, bitrate control, video controls and frame rate desired.

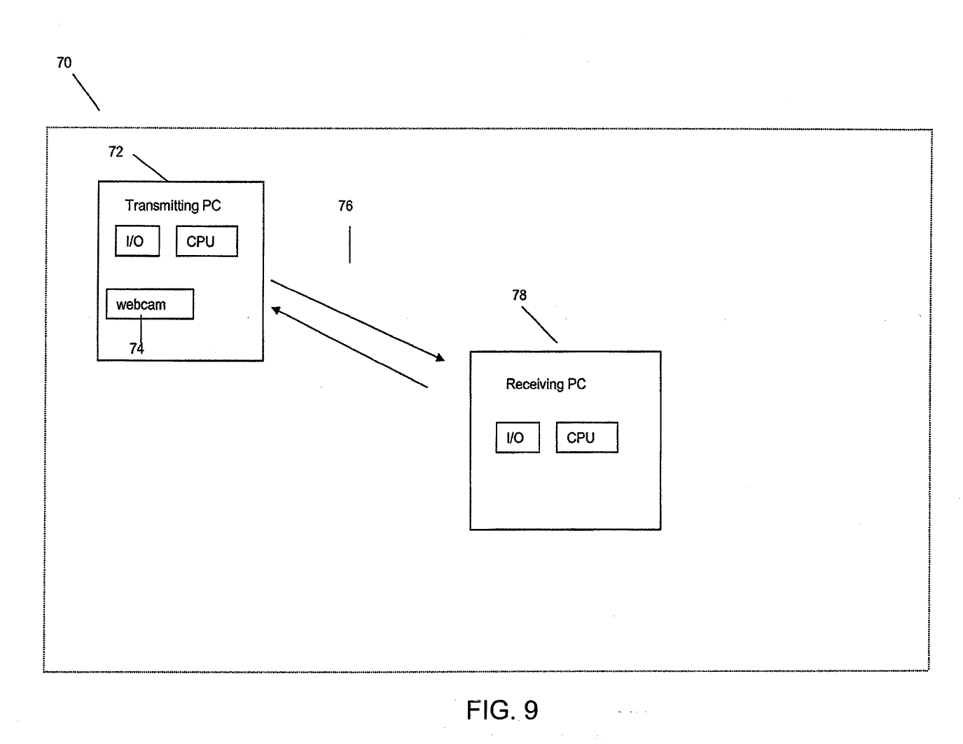

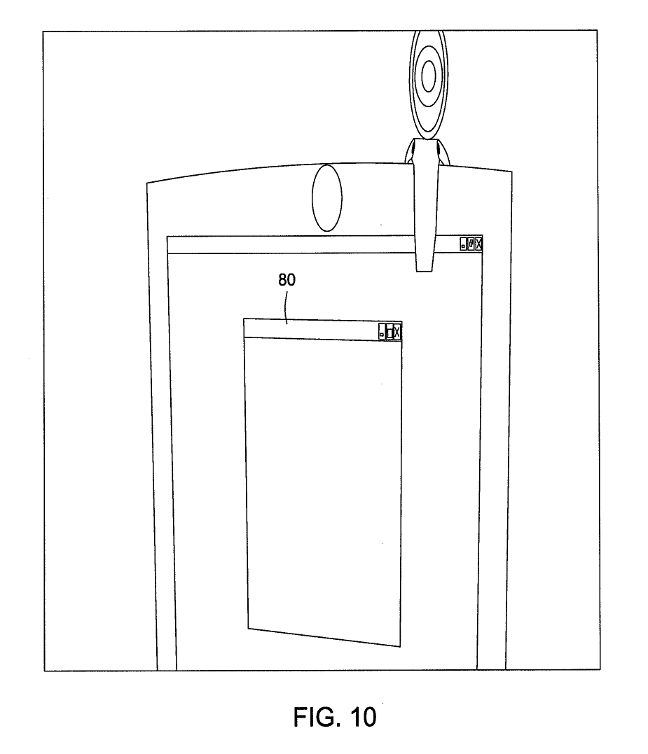

A second, all software-based embodiment of the system and method of the present invention is illustrated in FIGS. 8-10 with streaming capability (hereinafter Live Streamer). With reference to FIG. 8, digital video is captured from a common webcam 74, which produces raw RGB video. Software tools developed by FastVDO, LLC of Columbia, Md. for this system capture the video and audio into separate compressed streams, in H.264 video and MP3 or AAC audio, and separately packetize them in RTP streams. As seen in FIG. 9, the Live Streamer system 70 is shown wherein these streams are transmitted from a transmitting PC 72 on which the webcam 70 is connected via a local wireless network 76 (e.g. 802.11g) to a receiving PC 78, where they are depacketized, buffered, synchronized, and simultaneously played back on the screen of receiving PC 78. The identical software tool may used at both ends as a personal communications tool for bidirectional live communication employing two streams. The SmartPlayer software GUI 80 and received decoder display 82 are shown on the screens of the transmitting PC 72 and the receiving PC 78, respectively.

FIG. 10 shows a detailed view of Live Streamer tool, a variant of the SmartPlayer software GUI 80 of the communicator tool in accordance with the second embodiment, with a variety of settings including the IP address of the receiver to send to, with transmitter-side playback disabled for faster SW processing. The embodiment set forth in FIGS. 8-10 is of standard definition (SD) video (640×480, 30 fps, at 278 kb/s). It is noted that simultaneous SD video encode and decode is currently taxing for a single CPU in SW. On the reception side, the same content can be received in a handheld device.

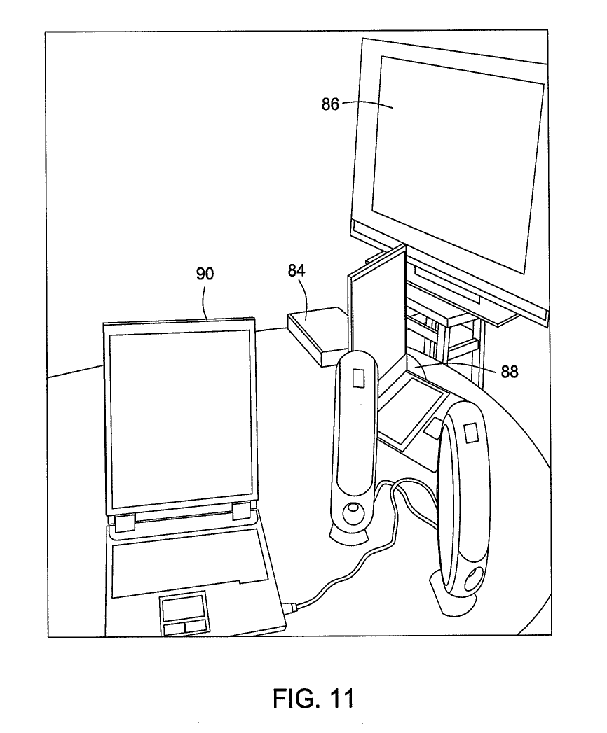

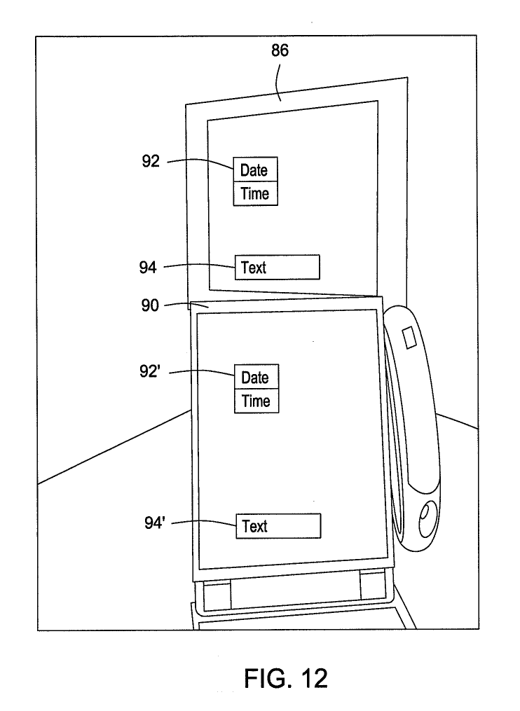

As shown in FIG. 11, a third embodiment according to the present invention of a hardware-based instantiation of SmartCapture™ is shown, with streaming capability. In this embodiment, the photograph discloses a video input from a DVD player 84, whose analog output is split between a TV monitor 86 and the SmartCapture device 88. The captured video is RTP packetized and transmitted via a wireless channel, and received and rendered by a receiving computer 90 with 1 second of latency achieved. FIG. 12 is a photograph in accordance with the third embodiment of the present invention, wherein said photograph demonstrates a “live” comparison of the TV monitor 86 (receiving raw analog output of DVD player) and the receiving PC 90 (wherein the picture shown has been captured, transmitted, received, and digitally SW rendered), showing little latency in the entire chain. The on-screen clocks 92 and 92′ are synchronized and enabled subtitles 94 and 94′ are transmitted and rendered clearly. The transmitter-side playback is disabled as unnecessary as playing the raw video output from DVD is shown as played prior to capture. This can be received on handhelds such as the Sony Vaio UX.

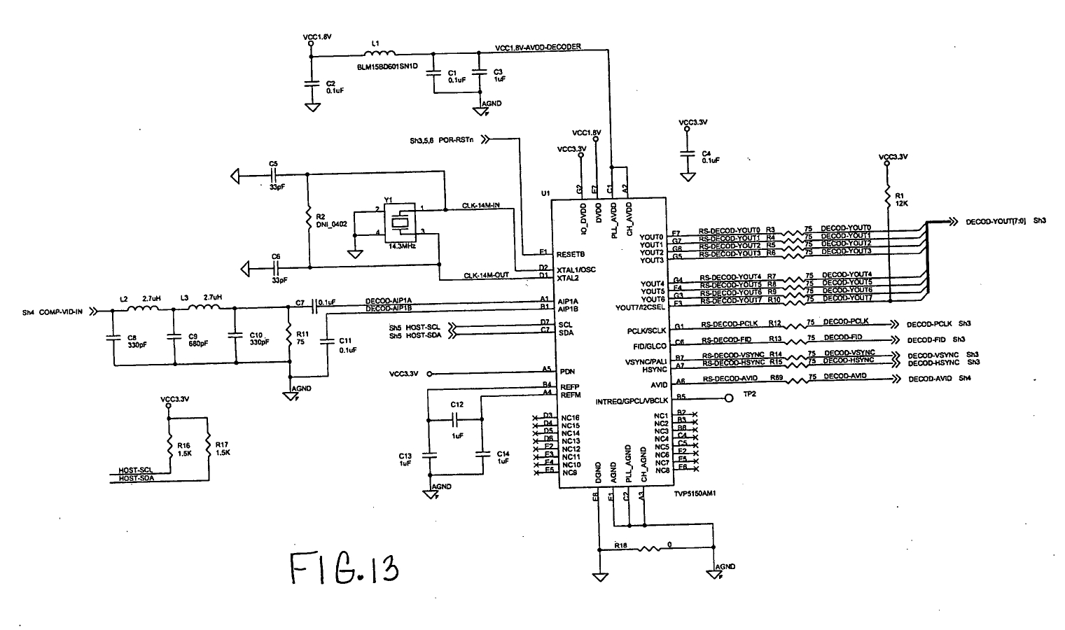

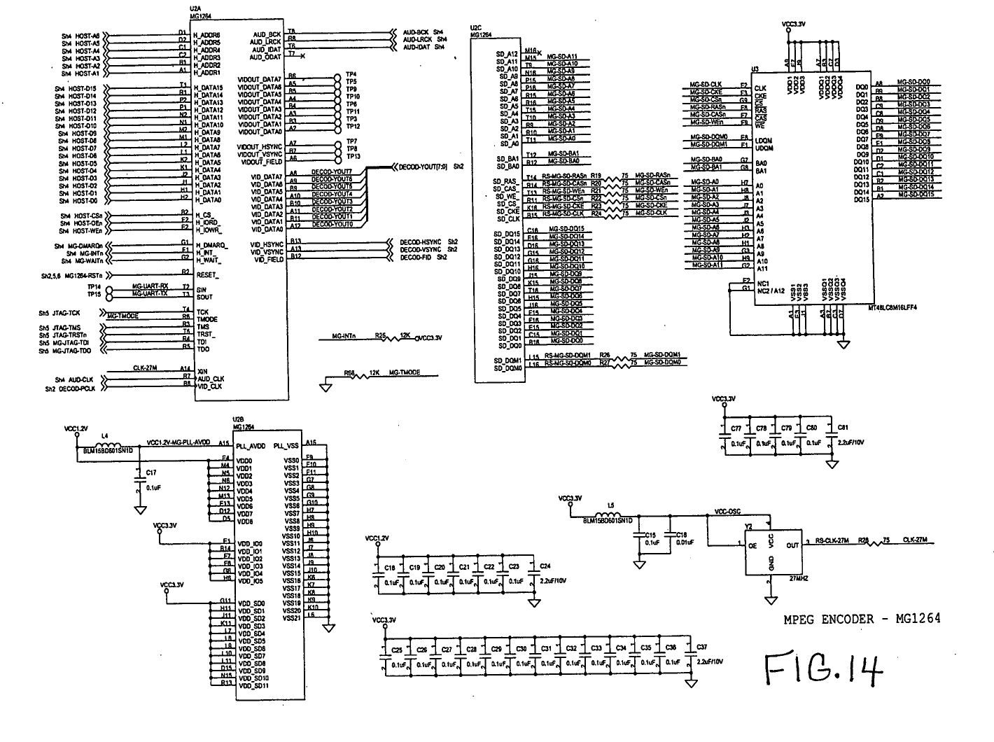

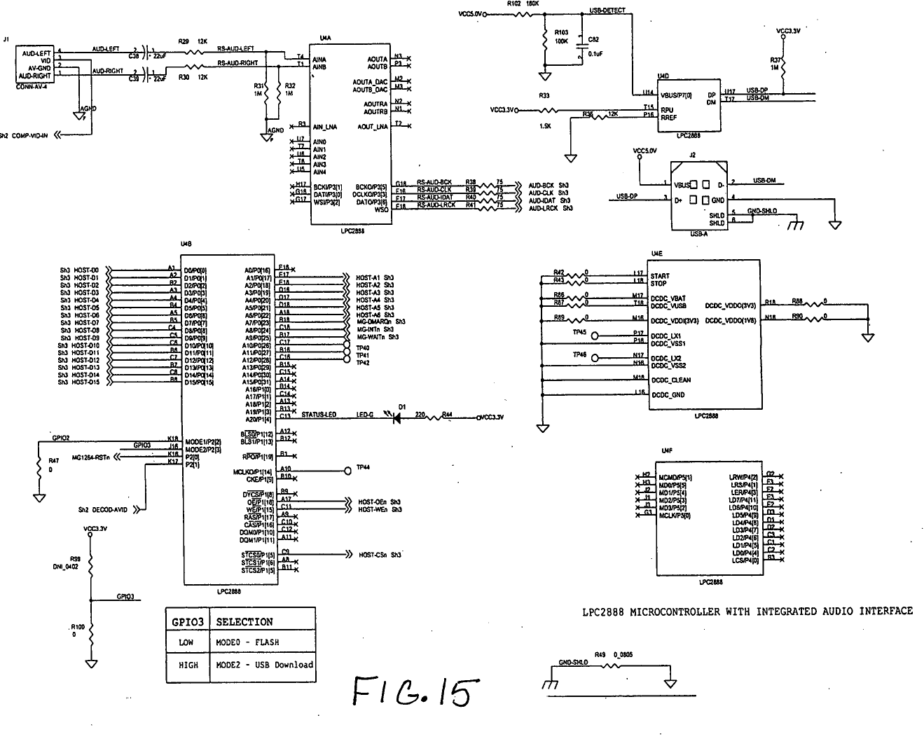

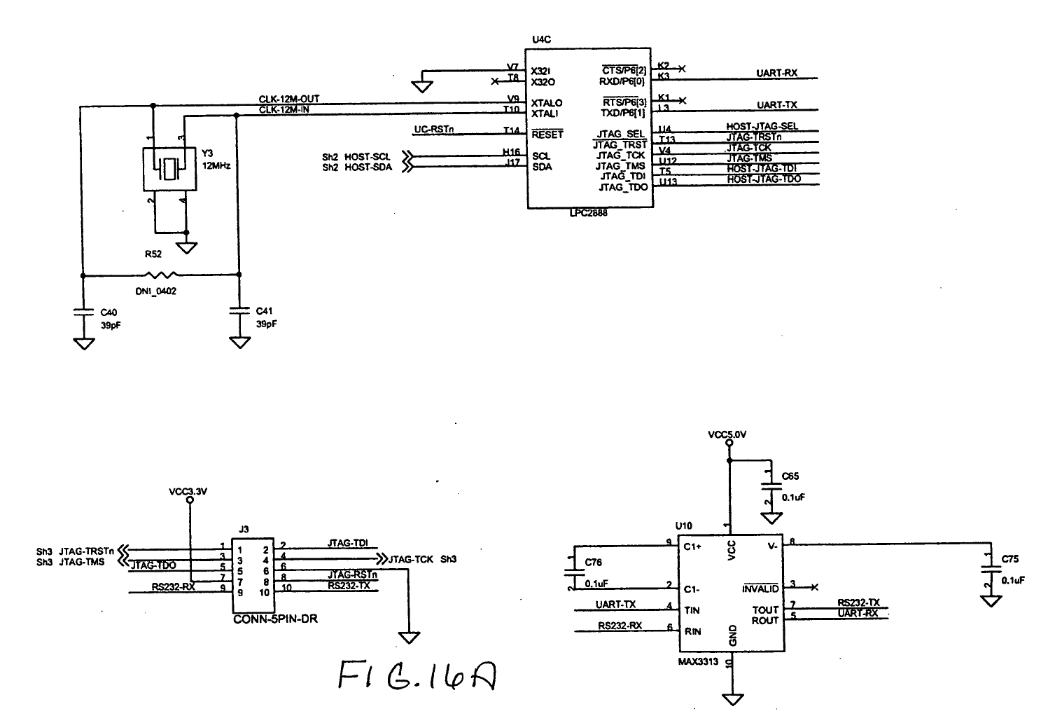

FIG. 13 is a detail view of hardware decoder circuitry 96 for the SmartCapture™ apparatus in accordance with a preferred embodiment of the invention. FIG. 14 shows a detail view of hardware encoder circuitry 98 for the SmartCapture™ apparatus in accordance with a preferred embodiment of the invention. FIG. 15 provides a perspective view of a host central processing unit 100 of a SmartCapture™ apparatus with power supply and external RS232 port in accordance with a preferred embodiment of the invention.

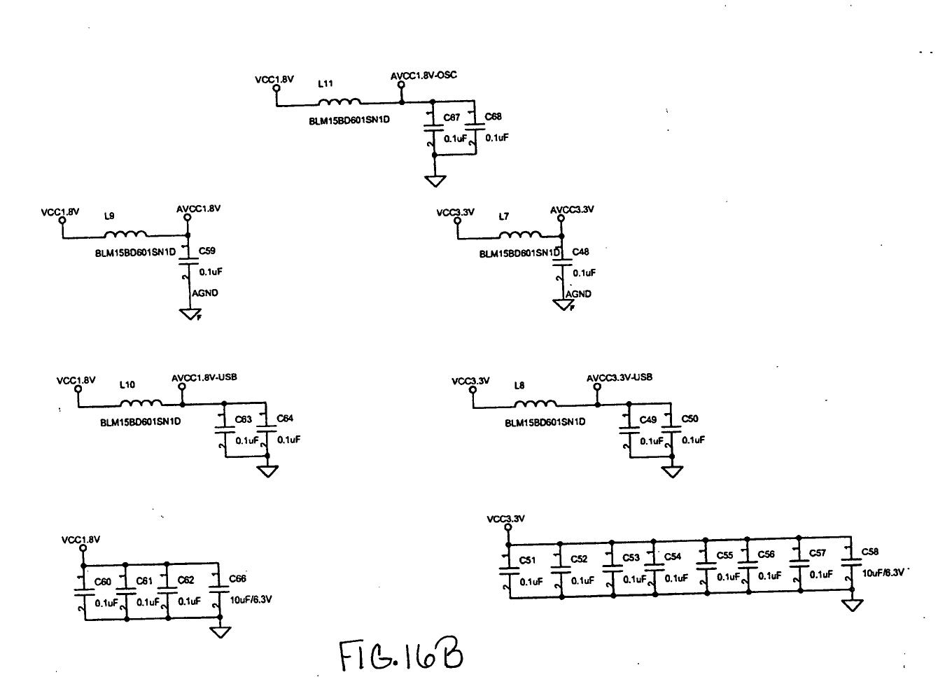

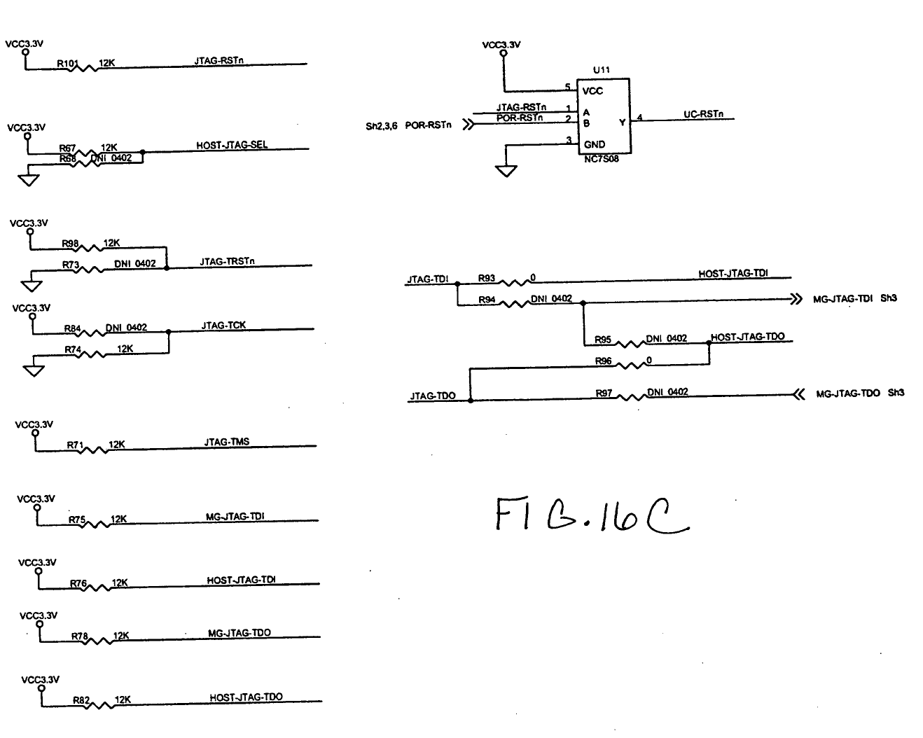

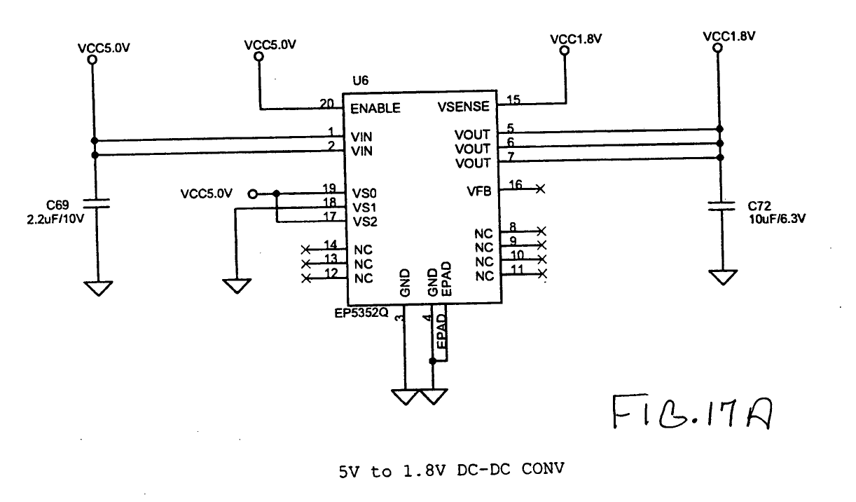

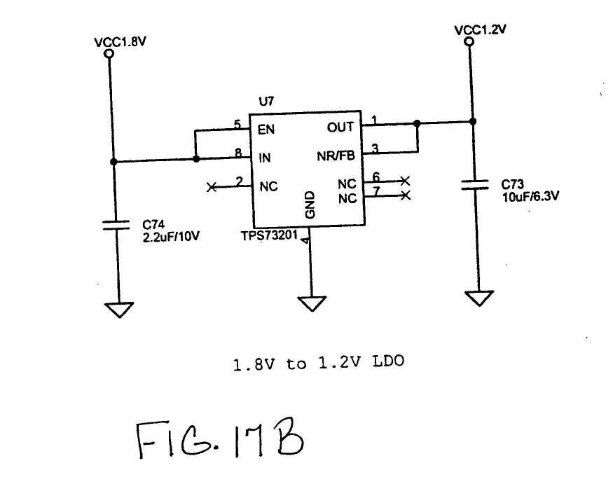

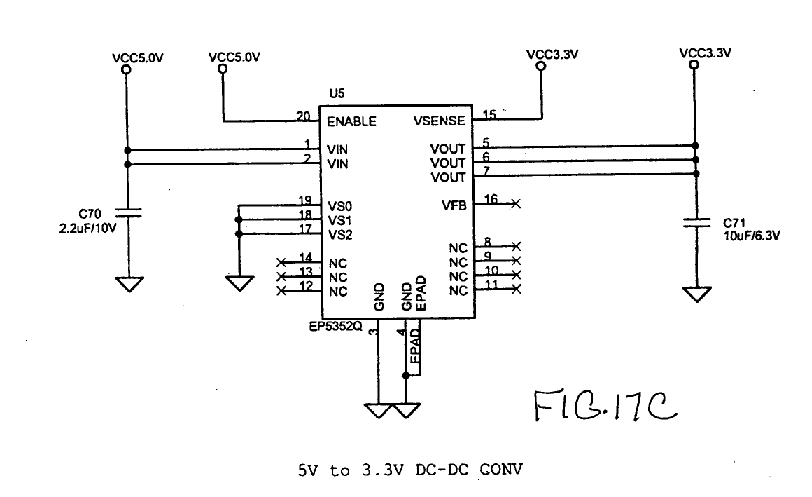

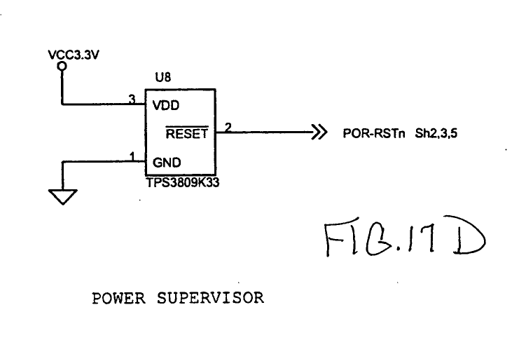

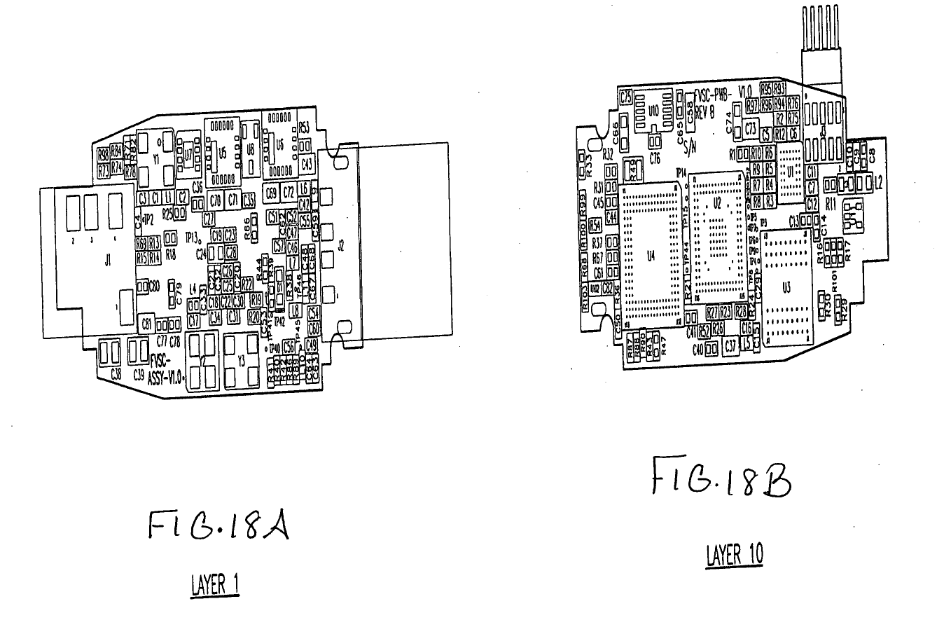

With respect to FIG. 16, a detail view of host central processing unit circuitry 102 is shown in accordance with a preferred embodiment of the invention. FIG. 17 is a perspective view illustrating the power circuitry 104 of the SmartCapture™ apparatus according to a preferred embodiment of the invention. FIG. 18A is a schematic overview diagram 106 of layer 1 of a printed circuit board assembly in accordance with an embodiment of the invention. FIG. 18B is a schematic overview diagram 108 of layer 10 of a printed circuit board assembly in accordance with an embodiment of the invention.

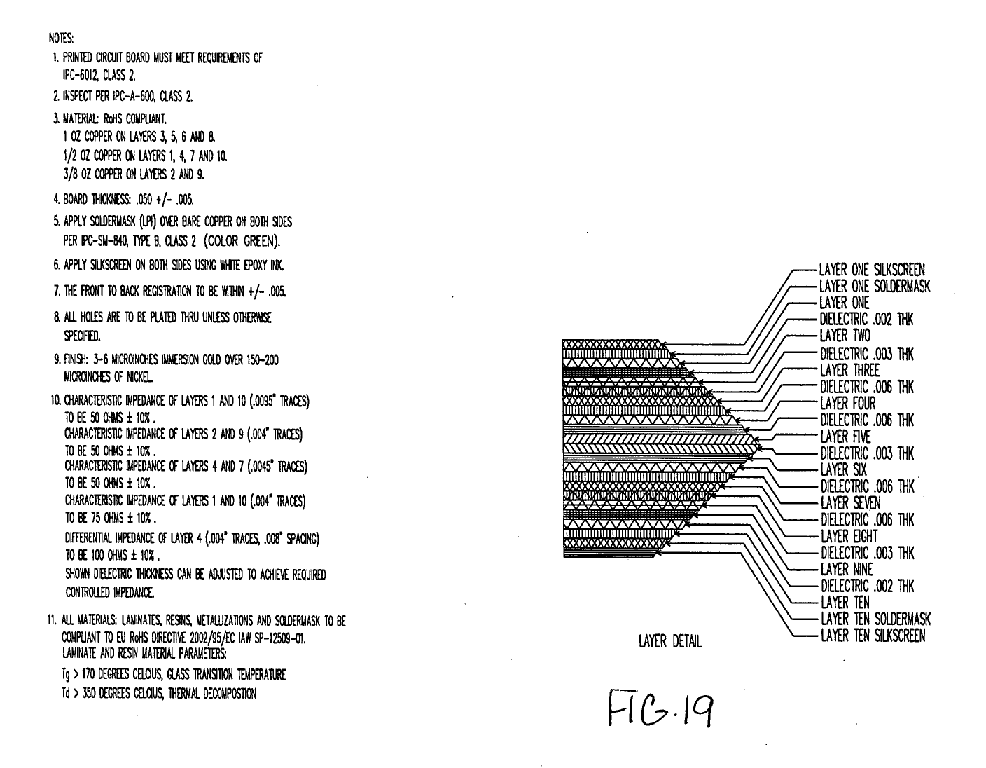

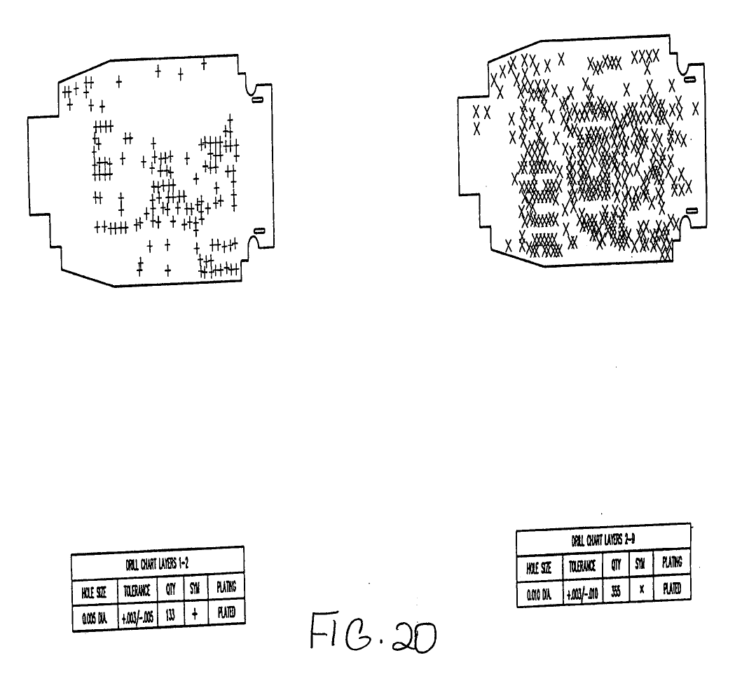

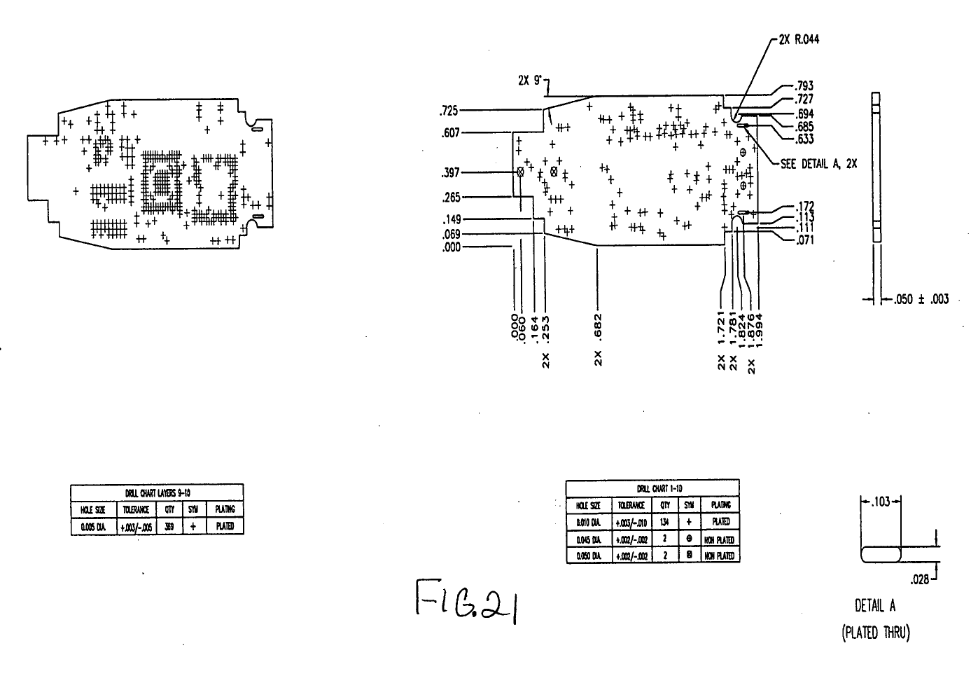

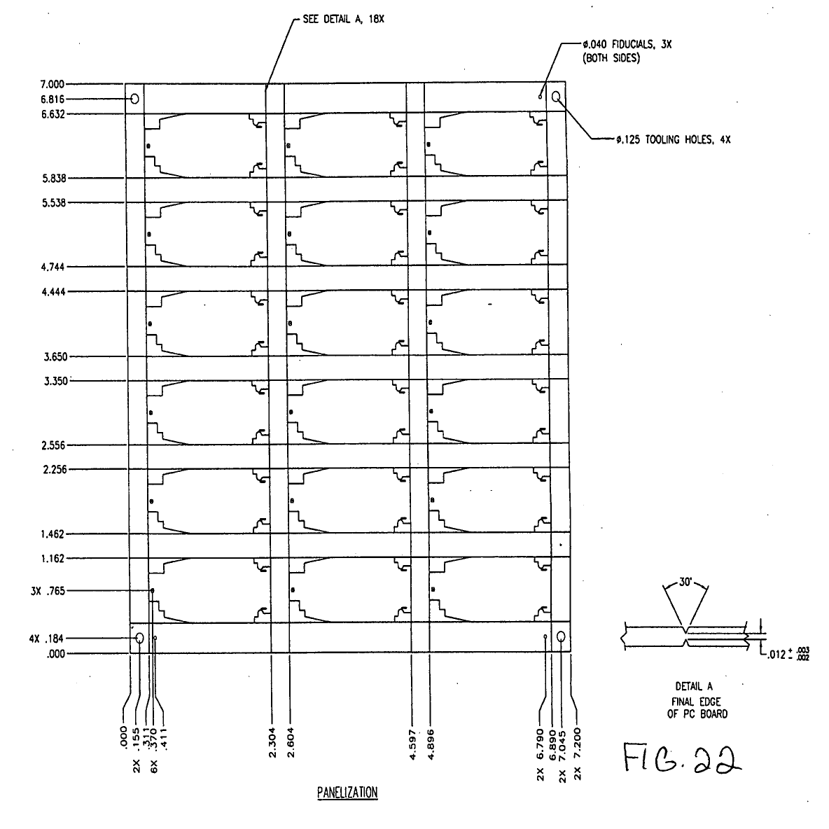

FIG. 19 illustrates the detail view of a 10-layer board 110 for the SmartCapture™ apparatus. FIG. 20 is a first drill chart 112 according to an alternative embodiment of the invention. FIG. 21 illustrates a second drill chart 114 according to an alternative embodiment of the invention. FIG. 22 shows a detail view of the SmartCapture™ panelization 116 according to an alternative embodiment of the invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for audio video capture and transmission, said system comprising:
a compact, real-time audio video capture and encoder apparatus for audio and video data capture and encoder processing;
a transmitting client facility having a real-time transmitter for transmitting the captured and encoded audio and video data; and
a receiving client facility having a real-time receiver, a decoder and a renderer apparatus for receiving, decoding, and rendering the captured and encoded audio and video data.

2. The system of claim 1, providing coding support for H.264/AVC video coding.

3. The system of claim 1, providing coding support for AAC audio coding.

4. The system of claim 2, providing coding support for one of the numerous enhanced versions of AAC audio coding, such as High Efficiency (HE)-AAC.

5. The system of claim 1, providing coding support for one of the low complexity versions of AAC audio coding, such as AAC-LC.

6. The system of claim 1, providing coding support for Scalable Video Coding.

7. The system of claim 1, providing coding support for advanced video coding using H.265 standard.

8. The system of claim 1, providing coding support for MP3 audio coding.

9. The system of claim 1, wherein the input video signal is analog video, in the form of NTSC, or PAL.

10. The system of claim 1, wherein the input audio signal is analog stereo.

11. The system of claim 1, wherein the input audio video signal is digital, and provided via a Serial Digital Interface (SDI).

12. The system of claim 1, wherein the input audio video signal is digital, and provided via a High Definition Serial Digital Interface (HD-SDI).

13. The system of claim 1, wherein the output is transported via a Universal Serial Bus (USB) interface.

14. The system of claim 1, wherein the output is transported via an Ethernet interface.

15. The system of claim 1, wherein the compressed signal is packaged in an MPEG-2 TS file format.

16. The system of claim 1, wherein the compressed signal is packaged in an MP4 file format.

17. The system of claim 1, wherein the streaming functionality is accomplished using the TCP/IP protocols.

18. The system of in claim 1, wherein the streaming functionality is accomplished using the Real-Time Protocol (RTP)/Real-Time Control Protocol (RTCP) protocols over Universal Data Port (UDP) connections.

19. A system for audio video capture and transmission with streaming capability, said system comprising:
a highly compact capture device having a hardware board configured for audio and video data capture and encoder processing;
an operating facility for receiving the captured and encoded audio and video data from the highly compact capture device;
wherein the operating facility has a graphical user interface for configuration of said capture device, a resource for packaging the data, and streaming means; and
wherein said operating facility further includes decoding means and displaying means for decoding and displaying a signal received from the capture device; and
wherein the system ingests a plurality of raw audio and/or video analog streams with optional auxiliary data, compresses streams in real-time, packages the compressed data in real-time into a common format for wide platform playback, delivers the data in real-time to an external system via a data transport protocol, provides the graphical user interface for selecting an apparatus parameter within the operating facility to format the compressed data, and streams the compressed data to a receiving device.

20. The system of claim 19, wherein the ingested streams are combined with auxiliary data.

21. The system of claim 19, wherein the auxiliary data is metadata.

22. The system of claim 19, wherein the auxiliary data is coded.

23. The system of claim 19, wherein the wide platform playback is MP4.

24. The system of claim 19, wherein the wide platform playback is MPEG-2 TS.

25. The system of claim 19, wherein the wide platform playback are elementary streams.

26. The system of claim 19, wherein the external system is a computer.

27. The system of claim 19, wherein the data transport protocol is USB.

28. The system of claim 19, wherein the data transport protocol is Ethernet

29. The system of claim 19, wherein the receiving device is a PC.

30. The system of claim 19, wherein the compressed formatted data is streamed using TCP/IP.

31. The system of claim 19, wherein the compressed formatted data is streamed using RTP/RTCP over UDP.

32. A method for audio video capture and transmission with streaming capability, said method comprising:
capturing a plurality of raw audio and/or video data in a highly compact capture device;
encoding the captured audio and/or video data processing;
receiving the captured and encoded audio and/or video data from the highly compact capture device;
configuring the capture device via a graphical user interface;
compressing streams of the audio and video data in real-time;
packaging the compressed data in real-time into a common format for wide platform playback;
delivering the data in real-time to an external system via a data transport protocol
providing the graphical user interface for selecting an apparatus parameter within the operating facility to format the compressed data, and
streaming the compressed data to a receiving device.

33. The method of claim 32, wherein the streams are combined with auxiliary data.

34. The method of claim 32, wherein the auxiliary data is metadata.

35. The method of claim 32, wherein the auxiliary data is coded.

36. The method of claim 32, wherein the wide platform playback is in the MP4 format.

37. The method of claim 32, wherein the wide platform playback is in the MPEG-2 TS format.

38. The method of claim 32, wherein the wide platform playback are as elementary streams.

39. The method of claim 32, wherein the external system is a computer.

40. The method of claim 32, wherein the data transport protocol is USB.

41. The method of claim 32, wherein the data transport protocol is Ethernet

42. The method of claim 32, wherein the receiving device is a PC.

43. The method of claim 32, wherein the compressed formatted data is streamed using TCP/IP.

44. The method of claim 32, wherein the compressed formatted data is streamed using RTP/RTCP over UDP.

45. A three-part system comprising: a highly compact apparatus called SmartCapture, a specialized hardware board, whose purpose is audio/video capture and encoder processing; a secondary apparatus, in software, called SmartPlayer, for the purpose of providing a graphical user interface for device configuration, a resource for data packaging, and for streaming; and a third apparatus, also instantiated in the SmartPlayer software, for decoding and displaying the received signal, which in total provides the following functionalities:
it ingests raw audio and/or video analog streams, together with optional auxiliary data such as metadata,
it compresses the raw combination of audio/video/auxiliary data streams in real-time (or faster) using H.264 and AAC, plus optional coding of auxiliary data,
it packages the compressed data in real-time (or faster) into a common format for wide platform playback, such as MP4, MPEG-2 TS, or elementary streams,
it delivers the data in real-time (or faster) to an external system such as a computer via common data transport protocols such as USB or Ethernet.
it optionally streams the compressed formatted data to a third device such as a PC, using common network transport protocols such as TCP/IP or RTP/RTCP over UDP,
it provides a simple graphical user interface for convenient apparatus parameter selection within the SmartPlayer, and
it provides an ability to receive, decode, and display the received, compressed signal, also within the SmartPlayer.
